(19) United States
(12) Patent Application Publication
(10) Pub. No.: US 2021/0223616 A1
(43) Pub. Date: Jul. 22, 2021

(54) DISPLAY DEVICE

(71) Applicant: InnoLux Corporation, Miao-Li County (TW)

(72) Inventors: Bo-Hao SONG, Miao-Li County (TW); Chih-Yung HSIEH, Miao-Li County (TW); Hong-Sheng HSIEH, Miao-Li County (TW)

(21) Appl. No.: 17/133,926

(22) Filed: Dec. 24, 2020

(30) Foreign Application Priority Data
Jan. 20, 2020 (CN) 202010064785.4

(51) Int. Cl. G02F 1/1335

(52) U.S. Cl. CPC G02F 1/133514; G02F 1/133512

(57) ABSTRACT

A display device is disclosed. The display device includes a display module, a peripheral member, and a cover glass. The peripheral member is disposed on the display module and partially overlaps the display module. The cover glass is disposed on the peripheral member. The peripheral member includes a color filter layer.

### CROSS REFERENCE TO RELATED APPLICATIONS

This application claims priority of China Patent Application No. 202010064785.4, filed on Jan. 20, 2020, the entirety of which is incorporated by reference herein.

### BACKGROUND OF THE DISCLOSURE

### Field of the Disclosure

The present disclosure relates to a display device, and particularly it relates to a display device that may reduce the color difference between a display region and a non-display region when the display device is turned off.

### Description of the Related Art

In recent years, in response to continuous improvement in display devices and the quality of displayed images, consumers' requirements for the design texture of display devices have also continuously increased. Generally, a display device includes a display region for displaying images and a non-display region enclosed by the display area. When the display device is turned off, it is desirable that the color (for example, black) presented in the display region is consistent with the color (for example, black) of the non-display region, so that the display device has visual unity, thereby enhancing the texture or quality of the product. However, in conventional display devices, because the non-display region is limited by the materials used to fabricate it, it is difficult to match the color of the non-display region to the color of the display region while in a non-display state.

### BRIEF SUMMARY OF THE DISCLOSURE

One embodiment of the present disclosure discloses a display device. The display device includes a display module, a peripheral member, and a cover glass. The peripheral member is disposed on the display module and partially overlaps the display module. The cover glass is disposed on the peripheral member. The peripheral member includes a color filter layer.

According to the display device of each of the above embodiments, the peripheral member surrounding the display module includes a color filter layer. By adjusting the aperture ratio of the pixels in the color filter layer and the area percentage of adjustment unit of each color, the color difference between the non-display region and the display region may be reduced when the display device is turned off.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 is a front view of a display device according to an embodiment of the disclosure;

FIG. 2 is a cross-sectional view showing the structure of the display device shown in FIG. 1;

FIG. 3 is a schematic diagram showing an example of a pattern of each adjustment unit in a color filter layer in a non-display region of the display device shown in FIG. 2;

FIG. 4 shows a reflection spectrum of each adjustment unit in the color filter layer shown in FIG. 3;

FIG. 5 shows a distribution in the CIE 1976 color space, which corresponds to a percentage of a color resist included in each adjustment unit in a color filter layer when an aperture ratio is 50%;

FIG. 6(a) is a schematic diagram showing other examples of a pattern of a color filter layer of the display device shown in FIG. 1;

FIG. 6(b) is a schematic diagram showing other examples of a pattern of a color filter layer of the display device shown in FIG. 1;

FIG. 6(c) is a schematic diagram showing other examples of a pattern of a color filter layer of the display device shown in FIG. 1; and

FIG. 7 shows a tolerance range of pixels per inch (PPI) of a display device where the human eye cannot perceive pixels under different viewing distances.

### DETAILED DESCRIPTION OF THE DISCLOSURE

The following description provides many different embodiments for implementing different features of the present disclosure. The elements and arrangements described in the following specific embodiments are only used to concisely express the disclosure, however, the disclosure is not limited thereto. For example, the description related to the structure where a first feature is on or above a second feature indicates that there is a direct contact between the first and second features or that another feature is placed between the first and second features such that the first feature does not directly contact with the second feature.

The words which are used to describe a spatial relationship, such as above or below, are only used to describe the relationship of one element or feature with respect to another element or feature in the drawings. In addition to the orientation described in the drawings, devices may be used or operate in different orientations. The shapes, sizes, and thicknesses shown in the drawings may not be drawn to scale or may be simplified for the purpose of clear description, and they are only provided for illustrative purposes.

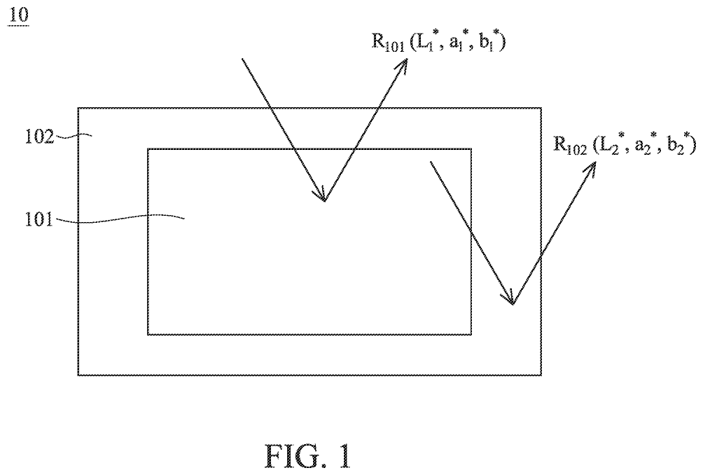

FIG. 1 is a front view of a display device 10 according to an embodiment of the disclosure. When viewed from the front, a display device 10 includes a display region 101 and a non-display region 102 surrounding the display region 101. When the display device 10 is turned off to cause the display region 101 to appear, for example, black, reducing the color difference between the non-display region 102 and the display region 101 can raise the visual unity of the display device 10.

Accordingly, the colors seen by the human eye must first be quantified. A color may be defined using the CIE 1976 (L*, a*, b*) color space. Each color of the CIE 1976 color space is determined by three coordinates, wherein L* represents the brightness of the color. L*=0 represents black, and L*=100 represents white. The hue represented by a* and b* is close to red when a* is a positive value, close to green when a* is a negative value, close to yellow when b* is a positive value, and close to blue when b* is a negative value. Assume that, when the display device 10 is turned off, a CIE 1976 color space coordinate of the display region 101 is represented by be R₁₀₁(L₁*, a₁*, b₁*), and a CIE 1976 color space coordinate of the non-display region 102 is represented by R₁₀₂(L₂*, a₂*, b₂*). Then, Equation 1, which is an equation that calculates the color difference value ΔE of the display region 101 and the non-display region 102. The smaller the color difference value ΔE is, the closer the colors of the display region 101 and the non-display area 102 are. When the color difference value ΔE is less than 3, the color difference between the display region 101 and the non-display region 102 cannot be recognized through the human eye.

ΔE=\sqrt{(L₁*−L₂*)²+(a₁*−a₂*)²+(b₁*−b₂*)²} Equation 1

In the past, the color of the non-display region was adjusted by mixing a plurality of inks. However, because of the limitations of ink materials, the colors that can be adjusted are also limited, and it is not easy to match the specific color of the display region. Therefore, in the present disclosure, patterned color resists are disposed in the non-display region 102. By adjusting the aperture ratio of the color resists and the area percentage of each color resist, the adjustable range of the non-display region 102 can be greatly increased, thereby improving the visual unity of the display region 101 and the non-display region 102.

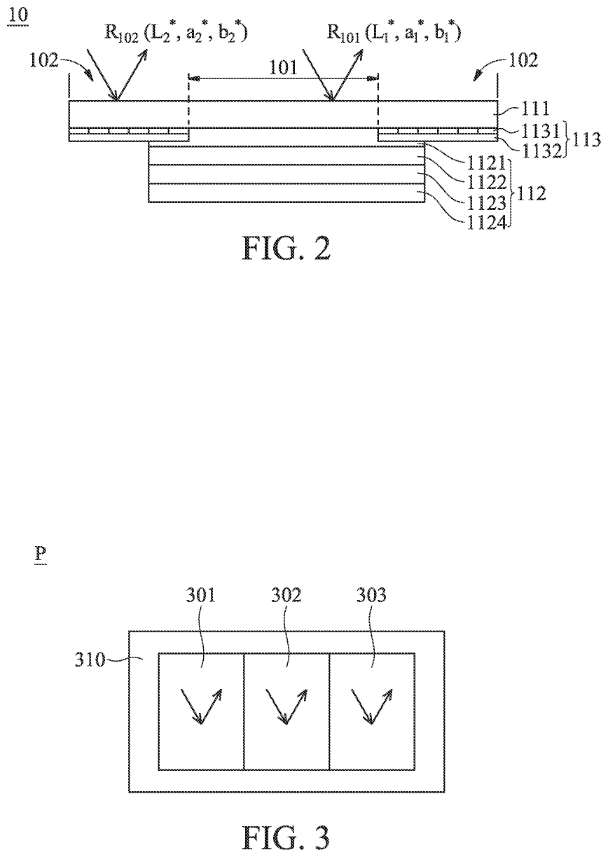

FIG. 2 is a cross-sectional view showing the structure of the display device 10 of FIG. 1. Referring to FIGS. 1 and 2, the display device 10 may include a display module 112, a peripheral member 113 disposed on the display module 112, and a cover glass 111 disposed on the peripheral member 113. The range where the peripheral member 113 and the cover glass 111 overlap corresponds to the non-display region 102, and the range where the peripheral member 113 and the cover glass 111 do not overlap corresponds to the display region 101.

The display module 112 may, for example, includes light emitting diodes (LEDs), liquid crystals, quantum dots (QDs), fluorescence, phosphor, other suitable materials, or the combination of the above materials, but the present disclosure is not limited thereto. In some embodiments, the light emitting diodes may include, for example, organic light emitting diodes (OLEDs), submillimeter light emitting diodes (mini LEDs), micro light emitting diodes (micro LEDs), or quantum dot light emitting diodes (QLEDs, QDLEDs), but the present disclosure is not limited thereto. As shown in FIG. 2, the display module 112 is disposed under the peripheral member 113. The display module 112 may include, for example, an adhesive material 1121, an upper polarizer 1122, a liquid crystal panel 1123, and a lower polarizer 1124, but the present disclosure is not limited thereto. The display module 112 can be bonded to the cover glass 111 and/or the peripheral member 113 through the adhesive material 1121. In some embodiments, in the normal direction of the cover glass 111, each of the adhesive material 1121, the upper polarizer 1122, the liquid crystal panel 1123, and the lower polarizer 1124 of the display module 112 are disposed under the peripheral member 113, and the peripheral member 113 and the display module 112 may partially overlap. When the display device 10 is turned on, the light from a backlight source (not shown) will sequentially pass through the lower polarizer plate 1124, the liquid crystal panel 1123, the upper polarizer 1122, the adhesive material 1121, and the cover glass 111 from below to emit out to display images. When the display device 10 is turned off, the backlight does not emit light, and the displayed color of the display region 101 seen by the user mainly come from the light that enters the human eye after the external light is reflected in the display area 101.

The peripheral member 113 may include a color filter layer 1131 and a light shielding layer 1132. The color filter layer 1131 is disposed on the display module 112. The light shielding layer 1132 may be disposed between the color filter layer 1131 and the display module 112. When the display device 10 is turned on, the light-shielding layer 1132 may be used to reduce the incidence of external light or the transmission of the backlight which can affect the display quality of the display module 112 or the light-shielding layer 1132 may be used to shield a component of the display device, the component of the display device such as a printed circuit board (PCB) or a backlight source, but the present disclosure is not limited thereto. When the display device 10 is turned off, since the peripheral member 113 is not a self-luminous region, the presented color of the peripheral member 113 comes from the light that enters the human eye after the external light is reflected in the non-display region 102.

The color filter layer 1131 may include an adjustment unit 301, an adjustment unit 302, and an adjustment unit 303, but the present disclosure is not limited thereto. The color filter layer 1131 may further include an adjustment unit 310. FIG. 3 is a schematic diagram showing an example of the pattern of each adjustment unit in the color filter layer 1131 in the non-display region 102 of the display device 10 of FIG. 2. Referring to FIG. 3, the adjustment unit 310 surrounds the adjustment unit 301, the adjustment unit 302, and the adjustment unit 303, but the disclosure is not limited thereto. The above adjustment units may correspond to different colors. For example, the adjustment unit 301 may correspond to red, the adjustment unit 302 may correspond to blue, the adjustment unit 303 may correspond to green, and the adjustment unit 310 may correspond to black, however the present disclosure is not limited thereto. In another embodiment, each adjustment unit may correspond to a combination of various colors.

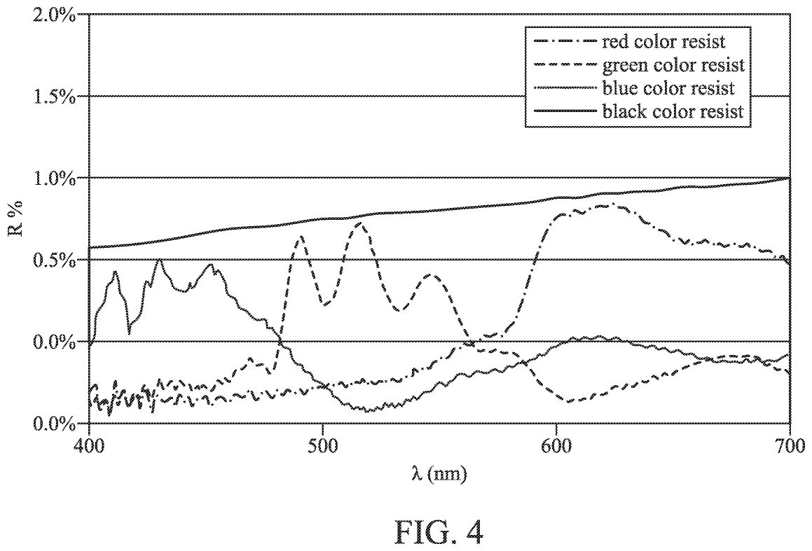

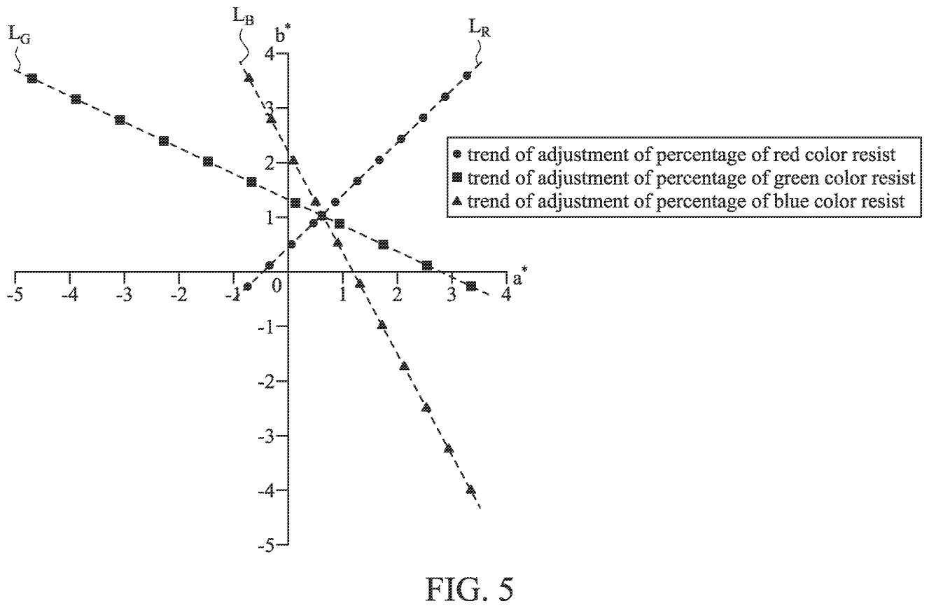

In some embodiments, the aforementioned adjustment units 310, 301, 302, and 303 may include color resists of different colors, and the color resist of each color has its own reflection spectrum. FIG. 4 shows the reflection spectrum of each of the adjustment units 301, 302, 303, and 310 in the color filter layer 1131 shown in FIG. 3. In FIG. 4, the horizontal axis represents the wavelength (nm) of the reflected light, and the vertical axis represents the reflectivity (percentage). As shown in FIG. 1, FIG. 3 and FIG. 4, the color resists of different colors, such as red, blue, green, and black color resists, have light distributions in different wavelengths. Therefore, by adjusting the area percentage of each of the adjustment units 301, 302, 303, and 310 in the color filter layer 1131, the color of the non-display region 102 can be adjusted. In an embodiment of the present disclosure, the adjustment unit 301 may include a red color resist, the adjustment unit 302 may include a blue color resist, and the adjustment unit 303 may include a green color resist. Referring to FIGS. 2 and 3, the ratio of the total area of the adjustment unit 301, the adjustment unit 302, and the adjustment unit 303 and the area of the adjustment unit 310 is defined as the aperture ratio, but the present disclosure is not limited thereto. In a case where the aperture ratio is set to 50%, the ranges of the color variation, which can be adjusted by the area percentages of the adjustment unit 301, the adjustment unit 302, and the adjustment unit 303, are shown in FIG. 5.

FIG. 5 shows distributions in the CIE 1976 color space, which correspond to the percentages of the red, blue, and green color resists included in the adjustment unit 301, the adjustment unit 302, and the adjustment unit 303 in the color filter layer 1131 when the aperture ratio is 50%. When the area percentage of one color resist is adjusted, the remaining area is divided equally between the other two color resists. For example, if the area of the red color resist area is adjusted, the area of each of the green and blue color resists is equal to the average of the sum of the areas of the adjustment units 301, 302, and 303 before the adjustment minus the adjusted are of the red color resist, but the present disclosure is not limited thereto. The straight line L_{R} represents the range of the color variation of the non-display region 102 in the CIE 1976 color space when the area percentage of the red color resist is adjusted. When the area percentage of the red color resist is larger, the values a* and b* are larger; when the area percentage of the red color resist is less, the values a* and b* are less. The straight line L_{G} represents the range of the color variation of the non-display region 102 in the CIE 1976 color space when the area percentage of the green color resist is adjusted. When the area percentage of the green color resist is larger, the value a* is smaller while the value b* is larger; when the area percentage of the green color resist is less, the value a* is larger while b* is less. The straight line L_{B} represents the range of the color variation of the non-display region 102 in the CIE 1976 color space when the area percentage of the blue color resist is adjusted. When the area percentage of the blue color resist is larger, the value a* is larger while the value b* is smaller; when the area percentage of the blue color resist is less, the value a* is less while b* is larger. When the area percentages of the red color resist, the green color resist, and the blue color resist are all ⅓, the color coordinate is the point where the three straight lines L_{R}, L_{G}, and L_{B} intersect. According to FIG. 1 and FIG. 5, in a case where the aperture ratio is fixed at 50%, by only adjusting the area percentage of each color resist, the color of the non-display region 102 can be adjusted such that the value a* is in a range of −5 to 4 (a*=−5˜4) and the value b* is in a range of −4 to 4 (b*=−4˜4).

Moreover, the aperture ratio is also set as a variable factor, the adjustable range of the color of the non-display region 102 will be wider, so that the color of the non-display region 102 is easily close to the color of the display region 101 in the non-display state In other words, the area percentage of each adjustment unit in the color filter layer 1131 can be adjusted so that the adjustment unit 301, the adjustment unit 302, and the adjustment unit 303 have different area percentages, thereby adjusting the color of the non-display region 102. Accordingly, the color difference ΔE between the peripheral member 113 and the display module 112 in the non-display state is less than 3, that is, the human eye cannot distinguish the color difference between the non-display region 102 and the display region 101 in the non-display state. In another embodiment of the present disclosure, for example, the area percentages of the four adjustment units 301, 302, 303, and 310 can be adjusted so that the four adjustment units 301, 302, 303, and 310 have different area percentages, thereby adjusting the color of the non-display region 102, but the disclosure is not limited thereto. In another embodiment of the present disclosure, for example, the four adjustment units 301, 302, 303, and 310 may have different shapes, such as rectangular or circular, etc., thereby adjusting the color of the non-display region, but the present disclosure is not limited thereto.

It should be noted that although the color filter layer 1131 is manufactured by using the same manufacturing method as color filters of the liquid crystal panel 1123, the color filter layer 1131 is arranged around the display module 112 but does not belong to the liquid crystal panel 1123. Therefore, the color filter layer 1131 is not manufactured at the same time as the color filters of the liquid crystal panel 1123. In addition, the color filter layer 1131 is used for adjustment of a specific color, for example, black, and, thus, the function of the color filter layer 1131 is different from the color-displaying function of the color filters in the liquid crystal panel 1123.

According to the above embodiments, the present disclosure disposes the peripheral member comprising the color filter layer in the non-display region of the display device and adjusts the aperture ratio of the color filter layer and the area percentage of each color filter unit. Thus, when the display device is turned off, the color difference between the non-display region in the peripheral member and the display region outside the peripheral member is reduced.

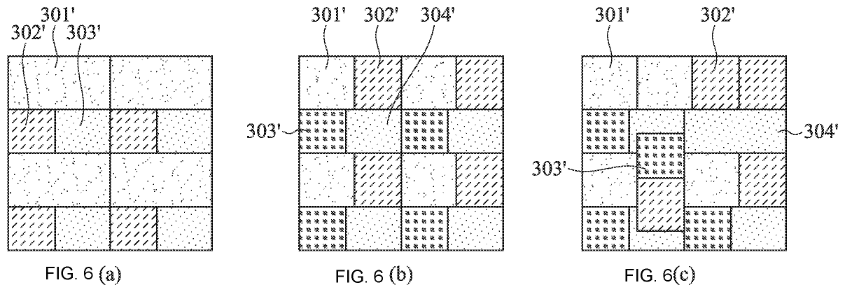

FIG. 6(a)-6(c) are schematic diagrams showing other examples of the pattern of the color filter layer in the display device of FIG. 1. As shown in FIG. 3, the color filter layer may include the adjustment units 301, 302, 303, and 310, and the adjustment units 301, 302, and 303 may have the same area and are arranged periodically, however, the present disclosure is not limited thereto. As shown in FIG. 6(a), the adjustment units 301′, 302′, and 303′ of the color filter layer correspond to different colors, for example, red, green, and blue, respectively and have different area percentages, and the adjustment units 301′, 302′, and 303′ are arranged periodically. In another embodiment, as shown in FIG. 6(b), the adjustment units 301′, 302′, 303′, and 304′ of the color filter layer correspond to different colors, for example, red, green, blue, and yellow, respectively and have different area percentages, and the adjustment units 301′, 302′, 303′, and 304′ are arranged periodically. In another embodiment, as shown in FIG. 6(c), the adjustment units 301′, 302′, 303′, and 304′ of the color filter layer correspond to different colors and may have different area percentages, and the adjustment unit 301′, 302′, 303′, 304′ are arranged non-periodically. In further another embodiment, at least two of the different color resists in the adjustment unit 301′, 302′, 303′, and 304′ may overlap each other or overlap each other in a certain direction (not shown), but the present disclosure is not limited thereto. In the embodiment, an area percentage of an adjustment unit is a percentage of the area of one of the adjustment units to the total area of all the adjustment units in the direction of the top view. For example, as shown in FIG. 6(a), in the cases where the adjustment units 301′˜304′ are observed for example through an optical microscope, the area percentage of the adjustment unit 301′ is a percentage obtained through dividing the area of the adjustment unit 301′ by the sum of the areas of all the adjustment units 301′˜304′.

In another embodiment of the present disclosure, for example, the four adjustment units 301′, 302′, 303′, and 304′ may have different shapes, thereby adjusting the color of the non-display region 102, but the present disclosure is not limited thereto. FIG. 6(a) shows an example of the definition of the shapes and the area percentages. Referring to FIG. 6(a), the adjustment unit 301′ and the adjustment unit 302′ have the same shape (for example, rectangle) but different area percentages. In some embodiments, the adjustment unit 301′ may be circular, while the adjustment unit 302′ may be rectangular, but the disclosure is not limited thereto.

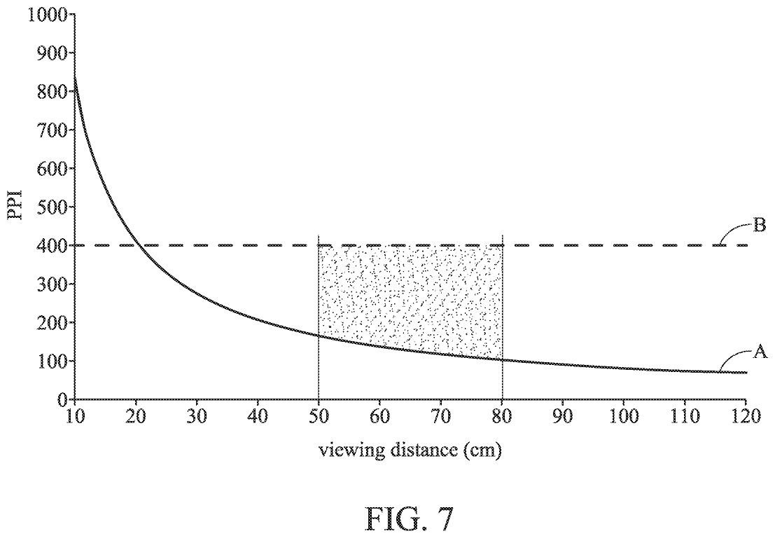

FIG. 7 shows a tolerance range of pixels per inch (PPI) of a display device where the human eye cannot perceive pixels under different viewing distances. The horizontal axis represents the viewing distance (cm), and the vertical axis represents the value representing pixels per inch (PPI). In order to prevent the human eye from perceiving the graininess of the pixels, the density of the pixels in the display device must be limited. Specifically, as shown by a curve A in FIG. 7, the curve A represents the lower limit that the human eye cannot perceive pixels at various viewing distances. Therefore, if the value representing pixels per inch (PPI) of the display device is above the curve A, the requirement for pixels being invisible to the human eye can be met.

According to FIG. 7, the value representing pixels per inch of each adjustment unit of the color filter layer in the non-display region may be determined according to the actual viewing distance of the display device. The dotted line B shown in FIG. is the upper limit of the density of the color filter layer in the manufacturing process. In the embodiment, the upper limit is 400 pixels per inch for example. Taking a vehicle display device as an example, the viewing distance in which the user watches the display device is about 50˜80 cm, and the value representing pixels per inch of each adjustment unit of the color filter layer can be set in the gray region above the curve A and below the dotted line B. Corresponding to FIG. 7, the upper and lower limits of the value representing pixels per inch for the viewing distances of 50˜80 cm are shown in Table 1.

TABLE 1

| Viewing distance | Lower limit of PPI | Upper limit of PPI |
|---|---|---|
| 50 cm | 165.9 PPI | 400 PPI |
| 60 cm | 138.3 PPI | 400 PPI |
| 70 cm | 118.5 PPI | 400 PPI |
| 80 cm | 103.7 PPI | 400 PPI |

If the condition that the human eye cannot perceive pixels is met in any vi win distance within the range of 50˜80 cm, the lower limit of pixels per inch (PPI) must be 165.9 pixels per inch (PPI) corresponding to the viewing distance of 50 cm, which is the strictest and safest PPI value for the vie distances within the range 50˜80 cm. In this way, by designing the pixel pitch of the color filter layer in the non-display region of the display device to cause the PPI value to be above 103.7 pixels per inch and below 400 pixels per inch (for example, 110 pixels per inch, 120 pixels per inch, or 300 pixels per inch), the user's perception of the presence of pixel particles in the non-display region can be degraded.

It should be noted that the above-mentioned pixel-pitch setting is based on the example that the display device is a vehicle display device. The display device disclosed in the present disclosure is not limited to a vehicle display device. However, the display device disclosed in the present disclosure may be applied to other devices, such as electronic bulletin boards, televisions, and the like. When the display device disclosed in the present disclosure is applied to devices with a longer viewing distance, such as outdoor electronic signage or spliced displays, the lower limit of the value representing pixels per inch can be adjusted based on the viewing distances shown in FIG. 7.

According to the above-mentioned embodiments, the present disclosure causes the color of the non-display region to be close to the color of the display region by disposing the color filter layer in the peripheral member in the non-display region of the display device. The present disclosure further sets the value representing pixels per inch of the adjustment unit of the color filter layer in the non-display region to prevent the user from perceiving the pixel particles.

Although this disclosure uses various embodiments above, they are only for reference rather than limiting the scope of this disclosure. Those skilled in the art may make few changes and modifications without departing from the spirit and scope of the present disclosure. Therefore, the above-mentioned embodiments are not used to limit the scope of the present disclosure, and the protection scope of the present disclosure should be defined by claims. The above-disclosed features can be combined, modified, replaced, or transferred with one or more disclosed embodiments in any suitable manner, and the present disclosure is not limited any specific embodiment.

What is claimed is:

1. A display device comprising:
a display module;
a peripheral member disposed on the display module and partially overlapping the display module; and
wherein the peripheral member comprises a color filter layer.

2. The display device as claimed in claim 1, wherein, in a non-display state, color difference between the peripheral member and the display module is less than 3.

3. The display device as claimed in claim 1, wherein the peripheral member further comprises a light shielding layer disposed between the color filter layer and the display module.

4. The display device as claimed in claim 1, wherein the color filter layer comprises a first adjustment unit, a second adjustment unit, and a third adjustment unit, and the first adjustment unit, the second adjustment unit, and the third adjustment unit correspond to different colors.

5. The display device as claimed in claim 4, wherein the first adjustment unit corresponds to red, the second adjustment unit corresponds to blue, and the third adjustment unit corresponds to green.

6. The display device as claimed in claim 4, wherein at least two of the first adjustment unit, the second adjustment unit, and the third adjustment unit are in a same shape.

7. The display device as claimed in claim 6, wherein area percentages of the at least two of the first adjustment unit, the second adjustment unit, and the third adjustment unit are different.

8. The display device as claimed in claim 4, wherein the first adjustment unit, the second adjustment unit, and the third adjustment unit are arranged periodically.

9. The display device as claimed in claim 4, wherein the color filter layer further comprises a fourth adjustment unit, and the first adjustment unit, the second adjustment unit, the third adjustment unit, and the fourth adjustment unit correspond to different colors.

10. The display device as claimed in claim 9, wherein the fourth adjustment unit surrounds the first adjustment unit, the second adjustment unit, and the third adjustment unit.

11. The display device as claimed in claim 10, wherein the fourth adjustment unit corresponds to black.

12. The display device as claimed in claim 9, wherein at least two of the first adjustment unit, the second adjustment unit, the third adjustment unit, and the fourth adjustment unit are in a same shape.

13. The display device as claimed in claim 12, wherein area percentages of the at least two of the first adjustment unit, the second adjustment unit, the third adjustment unit, and the fourth adjustment unit are different.

14. The display device as claimed in claim 13, wherein the first adjustment unit, the second adjustment unit, the third adjustment unit, and the fourth adjustment unit are arranged periodically.

15. The display device as claimed in claim 13, wherein the first adjustment unit, the second adjustment unit, the third adjustment unit, and the fourth adjustment unit are arranged non-periodically.

16. The display device as claimed in claim 9, wherein at least two of the first adjustment unit, the second adjustment unit, the third adjustment unit, and the fourth adjustment unit are in different shapes.

17. The display device as claimed in claim 9, wherein the first adjustment unit, the second adjustment unit, the third adjustment unit, and the third adjustment unit correspond to red, green, blue, and yellow, respectively.

18. The display device as claimed in claim 1, wherein the display device comprises a display region and a non-display region surrounding the display region, and the peripheral member corresponds to the non-display region.

19. The display device as claimed in claim 18, wherein the peripheral member is not overlapped with the display region.

20. The display device as claimed in claim 1, wherein the display module comprises a liquid crystal panel disposed under the peripheral member, wherein the liquid crystal panel comprises another color filter layer.
